(19) United States
(12) Patent Application Publication
(10) Pub. No.: US 2008/0104956 A1
(43) Pub. Date: May 8, 2008

(54) Turbocharger having inclined volutes

(75) Inventors: Kerry A. Delvecchio, Dunlap, IL (US); Richard W. Kruiswyk, Dunlap, IL (US); Paul W. Reisdorf, Dunlap, IL (US); Anees Hafiz, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/589,965

(22) Filed: Oct. 31, 2006

(51) Int. Cl. F02B 29/04; F02B 33/44

(52) U.S. Cl. 60/599; 60/605.1

(57) ABSTRACT

A turbocharger for a power system is disclosed. The turbocharger has an impeller wheel, which is rotatable about a central axis and includes a back face at least partially defining a reference plane substantially perpendicular to the central axis. In addition, the turbocharger includes a housing configured to at least partially enclose the impeller wheel. The housing also has at least one volute configured to fluidly communicate fluid with the impeller wheel. The entire length of the at least one volute from a turbocharger inlet is axially inclined relative to the reference plane so the fluid flows in both a radial and axial direction.

### U.S. GOVERNMENT RIGHTS

This invention was made with government support under the terms of Contract No. DE-FC26-05NT42423 awarded by the Department of Energy. The government may have certain rights in this invention.

### TECHNICAL FIELD

The present disclosure is directed to a turbocharger and, more particularly, to a turbocharger having axially oriented volutes.

### BACKGROUND

Internal combustion engines such as, for example, diesel engines, gasoline engines, and gaseous fuel powered engines are supplied with a mixture of air and fuel for subsequent combustion within the engine that generates a mechanical power output. In order to maximize the power generated by this combustion process, the engine is often equipped with a turbocharged air induction system.

A turbocharged air induction system includes a turbocharger that uses exhaust from the engine to compress air flowing into the engine, thereby forcing more air into a combustion chamber of the engine than the engine could otherwise draw into the combustion chamber. This increased supply of air allows for increased fuelling, resulting in an increased power output. A turbocharged engine typically produces more power than the same engine without turbo charging.

One commonly used turbocharger employs a radial inflow turbine with two or “twin” volutes disposed axially with respect to each other. In such a turbocharger, a turbine wheel is centrally located to receive exhaust from the volutes, and is connected to a compressor via a shaft. Each volute directs exhaust from different combustion chambers of the engine to the entire periphery of the turbine wheel, rotating the turbine wheel and the connected compressor. Each volute is associated with those combustion chambers firing at approximately the same time, such that pulses of pressurized exhaust exiting the combustion chambers may be efficiently directed to the turbine wheel, while minimizing undesirable pulse interactions within the engine.

Although the above-mentioned configuration minimizes undesirable pulse interactions within the engine, the efficiency of the turbocharger is limited by losses encountered when the exhaust gas is redirected by the turbine housing toward the turbine wheel. Typically, exhaust gas enters the turbine housing in a radial direction and exits the turbine housing in an axial direction. This change of direction can be as great as ninety degrees and consumes energy that could otherwise be used to rotate the turbine wheel.

One turbocharger that addresses the losses due to the change of direction of the exhaust gas is described in U.S. Pat. No. 5,094,587 (the '587 patent) issued to Woollenweber on Mar. 10, 1992. Specifically, the '587 patent describes a turbocharger having twin volutes. Both volutes are offset and curved so that exhaust gas enters the volutes in a purely radial direction and encounters the turbine wheel somewhere between a radial and axial direction. This arrangement has the effect of making the change in flow direction more gradual than typical turbochargers with a strictly radial inflow turbine.

Although the turbocharger of the '587 patent may reduce some flow losses of the radial inflow turbine, it still experiences losses generated through redirecting the exhaust flow. This redirection occurs because the exhaust gas still enters the volutes in a strictly radial direction. In addition, the volutes do not have any mechanism for controlling the flow of the exhaust gas as it leaves the volute and encounters the turbine wheel. Because of this deficiency, the exhaust gas is free to flow radially, axially, or somewhere in between and may lead to additional flow losses. The inconsistency of the flow in addition to the radial direction of the exhaust gas entering the volutes can reduce the efficiency of the turbocharger.

The turbocharger of the present disclosure solves one or more of the problems set forth above.

### SUMMARY OF THE INVENTION

In one aspect, the present disclosure is directed to a turbocharger. The turbocharger includes an impeller wheel, which is rotatable about a central axis and has a back face at least partially defining a reference plane substantially perpendicular to the central axis. In addition, the turbocharger includes a housing configured to at least partially enclose the impeller wheel. Furthermore, the housing has at least one volute configured to fluidly communicate fluid with the impeller wheel. The entire length of the at least one volute from a turbocharger inlet is axially inclined relative to the reference plane so the fluid flows in both a radial and an axial direction.

In another aspect, the present disclosure is directed to a method of operating a turbocharger. The method includes receiving a first flow of exhaust and simultaneously receiving a second flow of exhaust at a location axially offset and separate from the first flow of exhaust. The method further includes radially and axially directing the first and second flows of exhaust through a power generating device at the same inclined angle relative to a reference plane generally perpendicular to a central axis of the power generating device.

### BRIEF DESCRIPTION OF THE DRAWINGS

FIG. 1 is a schematic illustration of an exemplary disclosed power system;

FIG. 2 is a side view cross-sectional illustration of an exemplary disclosed turbocharger for use with the power system of FIG. 1;

FIG. 3 is an end view cross-sectional illustration of the turbocharger of FIG. 2; and

FIG. 4 is a graphical representation of the efficiency of various turbines.

### DETAILED DESCRIPTION

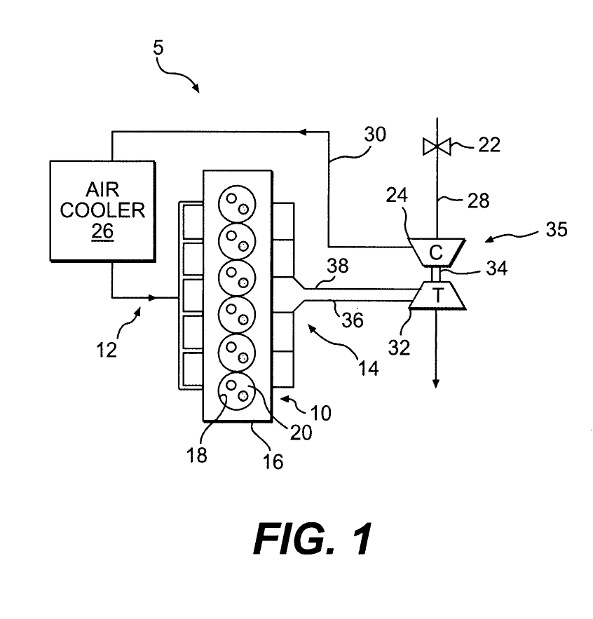

FIG. 1 illustrates a power system 5 having a power source 10, an air induction system 12, and an exhaust system 14. For the purposes of this disclosure, power source 10 is depicted and described as a four-stroke diesel engine. One skilled in the art will recognize, however, that power source 10 may be any other type of internal combustion engine such as, for example, a gasoline or a gaseous fuel-powered engine. Power source 10 may include an engine block 16 that at least partially defines a plurality of cylinders 18. A piston (not shown) may be slidably disposed within each cylinder 18 to reciprocate between a top-dead-center position and a bottom-dead-center position, and a cylinder head (not shown) may be associated with each cylinder 18.

Cylinder 18, the piston, and the cylinder head may form a combustion chamber 20. In the illustrated embodiment, power source 10 includes six such combustion chambers 20. However, it is contemplated that power source 10 may include a greater or lesser number of combustion chambers 20 and that combustion chambers 20 may be disposed in an “in-line” configuration, a “V” configuration, or in any other suitable configuration.

Air induction system 12 may include components that introduce charged air into power source 10. For example, air induction system 12 may include an induction valve 22, one or more compressors 24, and an air cooler 26. It is contemplated that additional components may be included within air induction system 12 such as, for example, additional valving, one or more air cleaners, one or more waste gates, a control system, a bypass circuit, and other means for introducing charged air into power source 10. It is also contemplated that induction valve 22 and/or air cooler 26 may be omitted, if desired.

Induction valve 22 may be fluidly connected to compressors 24 via a passageway 28 to regulate the flow of atmospheric air to power source 10. Induction valve 22 may embody, for example, a butterfly valve, a ball valve, a gate valve, or any other type of valve known in the art. Induction valve 22 may be solenoid-actuated, hydraulically-actuated, pneumatically-actuated, or actuated in any other manner in response to one or more predetermined conditions.

Compressor 24 may compress the air flowing into power source 10 to a predetermined pressure level. Compressors 24, if more than one is included within air induction system 12, may be disposed in a series or parallel relationship and fluidly connected to power source 10 via a passageway 30. Compressor 24 may embody a fixed geometry compressor, a variable geometry compressor, or any other type of compressor known in the art. It is contemplated that a portion of the compressed air from compressor 24 may be diverted from passageway 30 for other uses, if desired.

Air cooler 26 may embody an air-to-air heat exchanger, an air-to-liquid heat exchanger, or a combination of both, and be configured to facilitate the transfer of thermal energy to or from the compressed air directed into power source 10. For example, air cooler 26 may include a shell and tube-type heat exchanger, a corrugated plate-type heat exchanger, a tube and fin-type heat exchanger, or any other type of heat exchanger known in the art. Air cooler 26 may be disposed with passageway 30, between compressor 24 and power source 10.

Exhaust system 14 may include a means for directing exhaust flow out of power source 10. For example, exhaust system 14 may include one or more turbines 32 connected in a series or parallel relationship. It is contemplated that exhaust system 14 may include additional components such as, for example, particulate traps, NOx absorbers or other catalytic devices, attenuation devices, and other means for directing exhaust flow out of power source 10 that are known in the art.

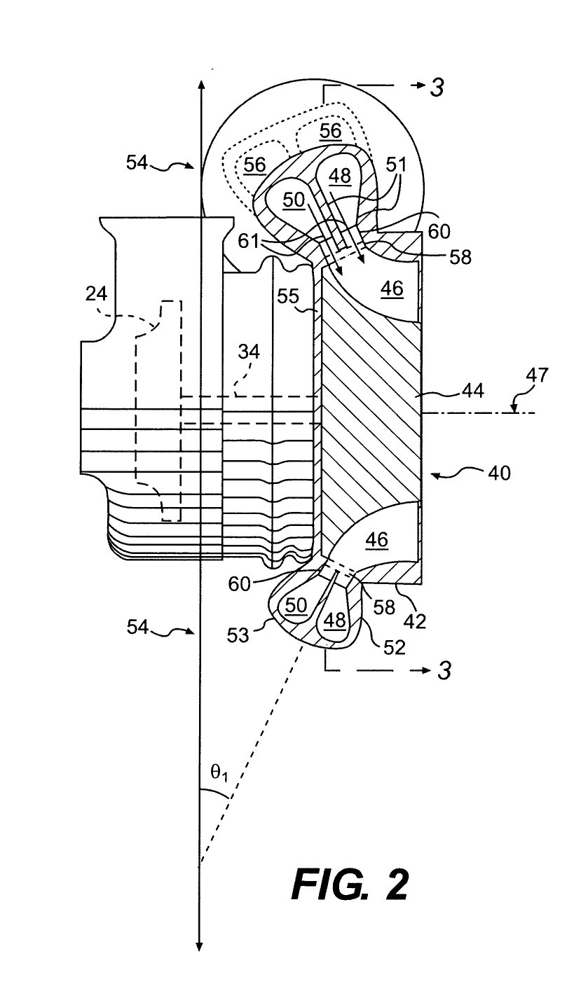

Each turbine 32 may be connected to one or more compressors 24 of air induction system 12 by way of a common shaft 34 to form a turbocharger 35. As the hot exhaust gases exiting power source 10 move through one of two exhaust passageways 36, 38 to turbine 32 and expand against blades (not shown in FIG. 1) of turbine 32, turbine 32 may rotate and drive the connected compressors 24 to compress inlet air. As illustrated in FIG. 2, turbine 32 may include a turbine wheel 40 fixedly connected to common shaft 34 and centrally disposed to rotate within a turbine housing 42.

Turbine wheel 40 may include a turbine wheel base 44 and a plurality of turbine blades 46. Turbine blades 46 may be disposed on the outer periphery of turbine wheel base 44 and may be adapted to rotate turbine wheel base 44 around a central axis of rotation 47 when driven by the expansion of hot exhaust gases. Turbine blades 46 may be rigidly fixed to turbine wheel base 44 using conventional means or may alternatively be integral with turbine wheel base 44 and formed through a casting or forging process, if desired.

Turbine housing 42 may at least partially enclose turbine wheel 40 and direct hot expanding gases from exhaust passageways 36 and 38 separately to turbine wheel 40. In particular, turbine housing 42 may be a divided housing have a first volute 48 and a second volute 50.

First volute 48 may be fluidly connected with exhaust passageway 36 such that the exhaust from a first group of combustion chambers 20 of power source 10 (referring to FIG. 1) firing at nearly the same time may be directed through exhaust passageway 36 to turbine wheel 40 via first volute 48. Second volute 50 may be fluidly connected with exhaust passageway 38 such that the exhaust from a second group of combustion chambers 20 of power source 10 firing at nearly the same time, but different from the first group, may be directed through exhaust passageway 38 to turbine wheel 40 via second volute 50. A wall member 51 may divide first volute 48 from second volute 50. Wall member 51 may be have a substantially planar structure that may aid in fabrication and symmetry of exhaust flow exiting first and second volutes 48, 50.

As is illustrated in FIG. 2, each of first and second volutes 48, 50 may have an attached portion 52 closer to turbine wheel 44 than a free portion 53. In other words, first and second volutes 48, 50 may be inclined at an angle θ₁ with the inclination originating at the inlets to each volute so that first and second volutes 48, 50 form a generally conical structure about axis 47 with the apex of the structure oriented toward turbine wheel 44. Angle θ₁ may pass symmetrically through wall member 51 and be defined relative to a plane 54, which may be substantially orthogonal to axis of rotation 47 and generally parallel to a back face 55 of turbine wheel 40. Angle θ₁ may be similarly referenced with respect to only axis of rotation 47, if desired. It should be understood that angle θ₁ may correspond to the desired direction of exhaust gas entering turbine 32 such that exhaust gas may flow through first and second volutes 48, 50 in a combined axial and radial direction rather than in a strictly radial direction. In one exemplary embodiment, angle θ₁ for each of first and second volutes 48, 50 may be in the range of approximately 20 to 30 degrees and preferably may be about 25 degrees. It should be understood that the magnitude of angle θ₁ producing the maximum turbine efficiency may differ among different power system configurations and induction systems. Such factors that may affect angle θ₁ may include, for example, the size and type of the air induction system, the size and type of the power system, and the spatial constraints of the environment in which the power system operates.

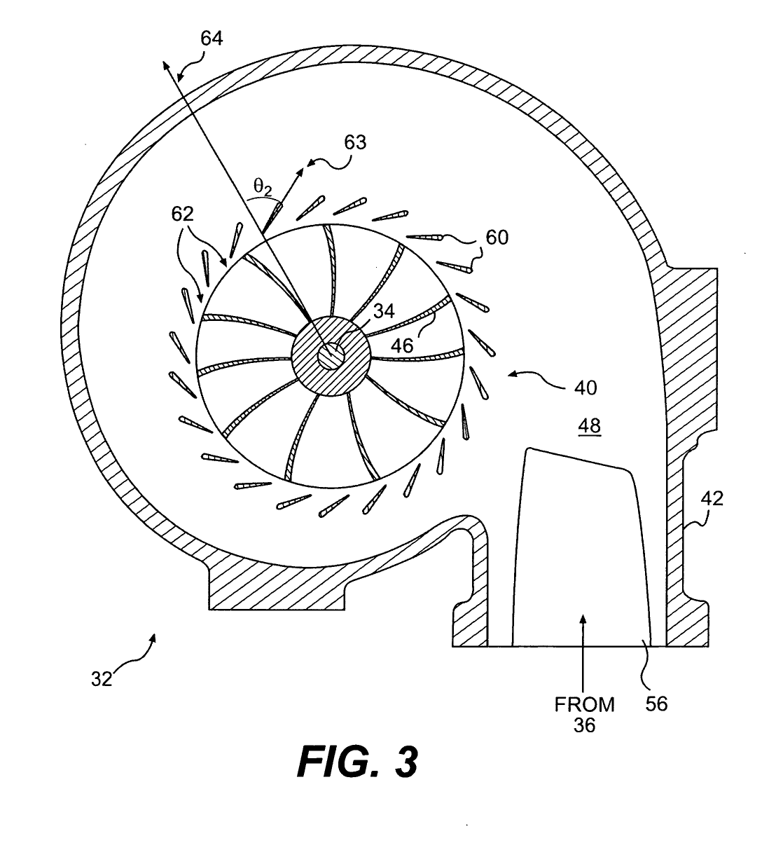

Exhaust gas may enter each of first and second volutes 48, 50 through an inlet 56 and exit through an annular channel-like outlet 58 fluidly connecting first and second volutes 48, 50 with a periphery of turbine wheel 40. Additionally, a plurality of vane members 60 may be disposed within each of first and second volutes 48, 50 between inlet 56 and the annular channel-like outlet 58. As illustrated in both FIGS. 2 and 3, vane members 60 may be fixedly connected to opposing sides of wall member 52 at a plurality of equally spaced locations, thereby dividing the annular channel-like outlet 58 into the plurality of finite outlet locations. In this configuration, axial inclination θ₁ of first and second volutes 48, 50 may symmetrically pass through vane members 60 and extend to annular channel-like outlet 58 allowing the flow of exhaust gas to exit first and second volutes 48, 50 and enter turbine wheel 40 in an radial and axial direction.

Arrows 61 may represent the flow of exhaust from inlet 56 through first and second volutes 58, 60, vane members 60, and annular channel-like outlet 58. It should be understood that exhaust gas from both exhaust passageways 36 and 38 may flow in the same general radial and axial direction. It should also be understood that the direction of the flow of exhaust gas in the radial and axial direction may remain substantially unchanged from inlet 56 to annular channel-like outlet 58.

As shown in FIG. 3, vane members 60 may be substantially equally oriented relative to axis of rotation 47 such that exhaust gases entering inlet 56 and flowing annularly through first and second volutes 48, 50 may be uniformly directed radially inward through the annular channel-like outlet 58 at a plurality of finite annular locations 62. Each vane member 60 may be oriented so that a symmetrical mid plane 63 of each vane member 60 is oriented at an angle θ₂, which may be referenced relative to a plane 64 originating at the center of shaft 34 and passing through a tip end portion of each vane member 60 closest to shaft 34. Angle θ₂ may be similarly referenced relative to a plane tangent to the periphery of turbine wheel 40, if desired. In one exemplary embodiment, angle θ₂ for vane members 60 may be in the range of approximately 65 to 70 degrees and preferably may be about 68 degrees. It should be understood that the magnitude of angle θ₂ producing the maximum turbine efficiency may differ among different power system configurations and induction systems. Such factors that may affect angle θ₂ may include, for example, the size and type of the air induction system, the size and type of the power system, and the pulse power produced by the engine cylinders.

It is contemplated that vane members 60 may be cast integrally with turbine housing 42 and finish fabricated, for example, through an electron discharge machining process. It is also contemplated that vane members 60 may alternatively be cast integrally with turbine housing 42 in finish form through a high precision casting process. It is further contemplated that vane members 60 may be initially separate from turbine housing 42 and, when assembled thereto, may be common to both first and second volutes 48, 50 (e.g., extending through wall member 52). It is additionally contemplated that vane members 60 may only be associated with only one of first and second volutes 48, 50, if desired.

### INDUSTRIAL APPLICABILITY

The disclosed turbocharger may be implemented into any power system application where charged air induction is utilized. In particular, because the disclosed turbocharger includes axially inclined volutes, annular channel-like outlets, and inclined nozzles, exhaust pulse energy may be fully and efficiently utilized without undesirable interactions or uniformity losses. The operation of power system 5 will now be explained.

Referring to FIG. 1, atmospheric air may be drawn into air induction system 12 by compressor 24 via induction valve 22, where it may be pressurized to a predetermined level before entering combustion chambers 20 of power source 10. Fuel may be mixed with the pressurized air before or after entering combustion chambers 20 and combusted by power source 10 to produce mechanical work and an exhaust flow of hot gases. The exhaust flow may be directed from power source 10 to turbine 32 where the expansion of the hot gases may cause turbine 32 to rotate, thereby rotating connected compressor 24 and compressing the inlet air. After exiting turbine 32, the exhaust flow may be released to the atmosphere.

As illustrated in FIG. 2, as the exhaust gases flowing from power source 10 enter turbine 32 via exhaust passageways 36 and 38, they may be separately and simultaneously directed through first and second volutes 48, 50, respectively, to turbine wheel 40. Because first and second volutes 48, 50 may be inclined at angle θ₁ relative to plane 54 along an entire length of both volutes, the flow of exhaust may be directed in both a radial direction around turbine wheel 40 and in an axial direction toward an outlet (not shown) of turbine 32 without substantial efficiency losses. Vane members 60 may further direct the flow of exhaust inward to the periphery of turbine blades 46 at the plurality of finite locations along annular channel-like outlet 58. It should be understood that vane members 60 may control the flow of exhaust in such a manner that the exhaust may only be allowed to flow in the combined radial and axial direction, wherein the axial component of the flow direction is inclined at angle θ₁ relative to plane 54. After imparting energy to and thereby urging turbine blades 46 to rotate, the exhaust gases may axially exit turbine 32 through outlet 66.

The advantages of axially inclined volutes and vane members may be realized in turbine 32. In particular, because the exhaust gas enters turbine 32 and flows through first and second volutes 48, 50 in a combined radial and axial direction, turbine 32 may encounter a lower amount of flow loss due to the change in direction of the exhaust gas. In addition, because turbine 32 includes vane members 60 within both first and second volutes 48, 50, the exhaust flow to turbine wheel 40 may be efficiently uniform. By lowering the flow losses and utilizing an efficiently uniform exhaust flow, the disclosed configuration may increase the overall efficiency of turbine 32.

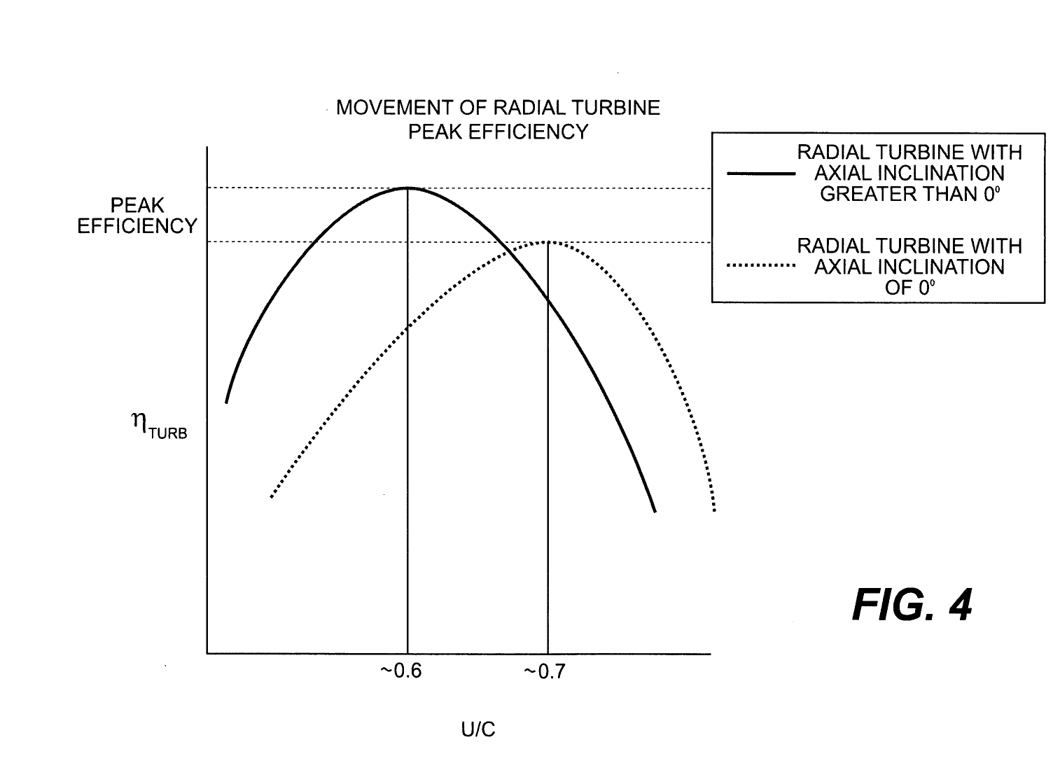

The effect of the disclosed configuration on turbine efficiency can be seen in the graphical representation of the efficiencies of various turbines at different velocity ratios illustrated in FIG. 4. The velocity ratio of a turbine is the ratio of the tangential blade velocity (U) of the turbine wheel to the isentropic speed (C) of the exhaust gas. The isentropic speed of the exhaust gas is proportional to the maximum amount of energy available from the flow of exhaust gas. Because pulse energy from engine cylinders 18 is typically greater at lower engine speeds, the isentropic speed of the exhaust gas is also greater at lower engine speeds.

Each turbine may have a tangential blade velocity that produces a peak energy output (turbine efficiency). If the turbine reaches its peak efficiency at higher engine speeds, the exhaust gas flow contains less energy and a lower isentropic exhaust gas speed resulting in a lower energy output of the turbine. In this situation, the peak efficiency occurs at a higher velocity ratio. For example, conventional radial turbines without inclined volutes and nozzles may achieve their peak efficiencies at a velocity ratio of approximately 0.7.

However, if the turbine were to reach the same tangential blade velocity mentioned above at lower engine speeds, the energy and isentropic speed of the exhaust gas may be greater. The greater available energy can lead to a greater energy output from the turbine. In this situation, the peak efficiency occurs at a lower velocity ratio.

By inclining first and second volutes 48, 50 and nozzles 60 in an axial direction, a greater portion of energy from the exhaust flow can be used to rotate turbine wheel blades 46. The extra energy may produce the peak efficiency tangential blade velocity at a lower engine speed. This may shift the velocity ratio at which the peak efficiency occurs to the left. For example, the peak efficiency of turbine 32 may occur at a velocity ratio of approximately 0.6. By shifting the peak efficiency to lower velocity ratios, turbine 32 may take advantage of the increased pulse energy produced by cylinders 18, and increase the overall efficiency by as much as 20-30 percent over conventional turbochargers. In addition, although the configuration may be contemplated for a turbine, it may be equally beneficial for a compressor as well.

It will be apparent to those skilled in the art that various modifications and variations can be made to the disclosed turbocharger. Other embodiments will be apparent to those skilled in the art from consideration of the specification and practice of the disclosed turbocharger. It is intended that the specification and examples be considered as exemplary only, with a true scope being indicated by the following claims and their equivalents.

1. A turbocharger, comprising:
an impeller wheel rotatable about a central axis and having a back face at least partially defining a reference plane substantially perpendicular to the central axis; and
a housing configured to at least partially enclose the impeller wheel and having at least one volute, including a vaned portion, configured to fluidly communicate a fluid with the impeller wheel, wherein the entire vaned portion of the at least one volute is inclined axially relative to the reference plane so that the fluid flows in both a radial and axial direction.

2. The turbocharger of claim 1, wherein the impeller wheel is a turbine wheel and the turbocharger further includes a compressor wheel and an outer periphery of the at least one volute is located axially closer to the compressor wheel than an inner periphery of the at least one volute.

3. The turbocharger of claim 2, wherein the at least one volute includes a substantially planar inner-side wall.

4. The turbocharger of claim 3, wherein the at least one volute has an annular opening in communication with the turbine wheel, and the axial inclination of the at least one volute extends to the annular opening.

5. The turbocharger of claim 4, wherein the vane portion includes a plurality of annularly disposed vane members inclined axially toward the compressor wheel relative to the reference plane.

6. The turbocharger of claim 1, wherein the at least one volute is axially inclined at substantially the same angle as the entire vaned portion.

7. The turbocharger of claim 5, wherein each annularly disposed vane member is radially inclined relative to a reference plane originating from the central axis and passing through a tip end portion of each vane member closest to the central axis, and the angle of radial inclination is within a range of approximately 65 to 70 degrees.

8. The turbocharger of claim 7, wherein the angle of radial inclination is approximately 68 degrees.

9. The turbocharger of claim 2, further including a second volute configured to fluidly communicate exhaust with the turbine wheel.

10. The turbocharger of claim 9, wherein the first and second volutes are axially inclined at substantially the same angle.

11. The turbocharger of claim 10, further including a wall member dividing the first and second volutes, wherein the wall member is substantially planar.

12. The turbocharger of claim 11, wherein an angle of axial inclination is within a range of approximately 20-30 degrees.

13. The turbocharger of claim 12, wherein the angle of axial inclination is approximately 25 degrees.

14. A method of operating a turbocharger, comprising:
receiving a first flow of exhaust;
simultaneously receiving a second flow of exhaust at a location axially offset and separate from the first flow of exhaust; and
radially and axially directing the first and second flows of exhaust through a vaned area and a power generating device at the same inclined angle relative to a reference plane perpendicular to a central axis of the power generating device.

15. The method of claim 14, wherein directing the first and second flows of exhaust further includes distributing the first and second flows of exhaust gas through a plurality of finite locations around a periphery of the power generating device.

16. The method of claim 15, wherein the angle of inclination is within a range of approximately 20-30 degrees.

17. The method of claim 16, wherein the angle of inclination is approximately 25 degrees.

18. A power system, comprising:
an engine having a plurality of combustion chambers and being configured to produce a power output and a flow of exhaust gases;
a first exhaust passageway associated with at least a first of the plurality of combustion chambers;
a second exhaust passageway associated with at least a second of the plurality of combustion chambers; and
a turbocharger in fluid communication with the first and second exhaust passageways, the turbocharger including:
a turbine wheel rotatable about a central axis and having a back face at least partially defining a reference plane substantially perpendicular to the central axis; and
a housing configured to at least partially enclose the turbine wheel and having:
a first volute configured to fluidly communicate exhaust with the turbine wheel, wherein at least a portion of the first volute is inclined axially toward a compressor wheel relative to the reference plane so that an outer periphery of the first volute is located axially closer to the compressor wheel than an inner periphery of first volute and the exhaust flows in both a radial and axial direction;
a second volute configured to fluidly communicate exhaust with the turbine wheel, wherein at least a portion of the second volute is inclined axially toward a compressor wheel relative to the reference plane so that an outer periphery of the second volute is located axially closer to the compressor wheel than an inner periphery of second volute and the exhaust flows in both a radial and axial direction;
a vaned portion including a plurality of annularly disposed vane members associated with at least one of the first and second volutes, wherein the axial inclination of the at least one of the first and second volutes extends through the entire vaned portion; and
an annular opening associated with each of the first and second volutes and in communication with the turbine wheel, wherein the axial inclination of the first and second volutes extends to the annular opening.

19. The turbocharger of claim 18, wherein the first and second volutes are axially inclined at substantially the same angle.

20. The turbocharger of claim 19, further including a wall member dividing the first and second volutes, wherein the wall member is substantially planar.
